(19) United States
(12) Patent Application Publication
(10) Pub. No.: US 2008/0107393 A1
(43) Pub. Date: May 8, 2008

(54) METHOD AND APPARATUS TO REPRODUCE AUDIO VISUAL DATA COMPRISING APPLICATION HAVING INDETERMINATE START TIME

(75) Inventor: Kil-soo JUNG, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/746,731

(22) Filed: May 10, 2007

(30) Foreign Application Priority Data
Nov. 6, 2006 (KR) 2006-108830

(51) Int. Cl. H04N 5/91

(52) U.S. Cl. 386/83

(57) ABSTRACT

A method and apparatus to reproduce audio visual (AV) data, including an application having an indeterminate start time, and a computer readable recording medium having embodied thereon a computer program to execute the method are provided. The method of reproducing AV data includes: reading the reproduction sequence information of the AV data and determining whether an application having an indeterminate start time is included; and if the application is included, displaying on an input apparatus that an executable application exists. According to the method and apparatus, a user can learn whether an application having an indeterminate start time is included, and can thereby easily use all applications provided by content producers.

### CROSS-REFERENCE TO RELATED APPLICATION

This application claims the benefit of Korean Application No. 2006-108830, filed Nov. 6, 2006 in the Korean Intellectual Property Office, the disclosure of which is incorporated herein by reference.

### BACKGROUND OF THE INVENTION

1. Field of the Invention

Aspects of the present invention relate to reproduction of audio visual (AV) data, and more particularly, to a method and apparatus to reproduce AV data that includes an application having an indeterminate start time, and a computer readable recording medium having embodied thereon a computer program to execute the method.

2. Description of the Related Art

Applications may be included in audio visual (AV) data and be reproduced or executed when video data thereof is reproduced. Such applications can be applications that are synchronized with a video reproduction time and executed at a predetermined time, and applications that have an indeterminate start time, which is determined or executed by a user input. AV data having structures illustrated in FIG. 1 or FIG. 2 may be recorded on an information storage medium on which AV data is recorded, together with information on a reproduction sequence of the AV data.

Referring to FIG. 1, shown are a plurality of applications 102 that may be executed while being synchronized with video data 101. Also shown is a plurality of applications 103 that each have an indeterminate start time. The application 102 and 103 are multiplexed with the video data 101, which is the main data for reproduction. As shown, the video data 101 and the plurality of applications 102 and 103 are stored as one main program 100.

Referring to FIG. 2, shown are a plurality of applications 202 that may be executed while being synchronized with video data 201, and are multiplexed with the video data 101, which is the main data for reproduction. The video data 201 and the plurality of applications 202 are stored as one main program 200. Also shown is a plurality of applications 203 that each has an indeterminate start time. The plurality of applications 203 is stored as a sub program 210 separate from the main program 200. A program is a term that refers to a stream type or file type data defined in the MPEG2 standard or the like.

FIG. 3 is a diagram illustrating a structure of a reproduction apparatus to reproduce AV data recorded on an information storage medium according to a related art technology. The reproduction apparatus includes, a user operation controller 302 to interpret control information input by a user and transfer the result of the input to a navigation manager 303, a buffer 301 to buffer data read from an information storage medium, and the navigation manager 303 to control reproduction of AV data based on the reproduction sequence information of the AV data and/or the reproduction control information input from the user operation controller 302. The reproduction apparatus also includes a plurality of decoders 310 to decode AV data based on control of the navigation manager 303, and an AV renderer 304 to render video and audio data decoded by the decoders 310 to thereby output the video and audio data. The plurality of decoders 310 include a video decoder 311 to process video data based on control of the navigation manager 303, and one or more application decoders 312 to decode and interpret applications, such as audio, caption, and menus.

Under the control of the navigation manager 303 based on the reproduction sequence information, each of the applications that are executed while being synchronized with a video reproduction time is processed by the application decoder 312 at a specified start time, is input to the AV renderer 304, and executed (or outputted). However, for applications that each have an indeterminate start time, at a time specified by the reproduction sequence information, even though an operation state of the application becomes a valid state (that is, a state in which reading of the application data from the information storage medium is finished and the application data is waiting for a decoding operation), the application is neither executed nor displayed on a screen.

Accordingly, in the case of the applications that each have an indeterminate start time and are executable only when a user selects one of them, even when the applications are included in AV data, the user does not recognize the applications, and the applications may not even be executed.

### SUMMARY OF THE INVENTION

Aspects of the present invention includes a method and apparatus to reproduce audio visual (AV) data capable of efficiently informing a user about the inclusion of an application having an indeterminate start time, and a computer readable recording medium having embodied thereon a computer program to execute the method.

According to an aspect of the present invention, a method of reproducing audio visual (AV) data includes reading reproduction sequence information of the AV data and determining whether an application having an indeterminate start time is included; and if the application is included, displaying on an input apparatus that the application exists and is executable.

According to an aspect of the present invention, the method may further include, if a command from the input apparatus to execute the application is received, executing the application.

According to an aspect of the present invention, the displaying on the input apparatus may be performed at a time when reading of application data to execute the application is completed.

According to an aspect of the present invention, the displaying on the input apparatus may be performed when information on the application is set to be not displayed as an on-screen display (OSD).

According to another aspect of the present invention, an apparatus to reproduce audio visual (AV) data includes a user operation controller to control an input apparatus; and a navigation manager to interpret reproduction sequence information of the AV data, to thereby control the reproduction of the AV data, and if determined that an application having an indeterminate start time is included, notifies the user operation controller of the inclusion, wherein if the notification from the navigation manager is received, the user operation controller controls the input apparatus so that the presence of an executable application can be indicated.

According to an aspect of the present invention, if a command from the input apparatus to execute the application is received, the user operation controller may generate reproduction control information corresponding to the command and transfer the control information to the navigation manager, and the navigation manager may control an application decoder corresponding to the application by referring the control information to the reproduction control information, so that the application can be decoded and executed.

According to an aspect of the present invention, the input apparatus may be a remote controller or a front panel of the apparatus to reproduce AV data.

According to another aspect of the present invention, a method to reproduce audio visual data, includes detecting an existence of a selectable application from a reproduced sequence information of the audio visual data, and outputting a notice of the existence of the selectable application only when the selectable application is selectable, based on the detection.

According to an aspect of the present invention, an apparatus to reproduce audio visual data, includes: an optical pickup to read and reproduce audio visual data; and a manager to detect an existence of a selectable application from a reproduced sequence information of the audio visual data, and output a notice of the existence of the selectable application only when the selectable application is selectable, based on the detection.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent by and more readily appreciated from the following description of the aspects, taken in conjunction with the accompanying drawings of which:

FIG. 1 is a diagram illustrating a related art audio visual (AV) data structure recorded on an information storage medium;

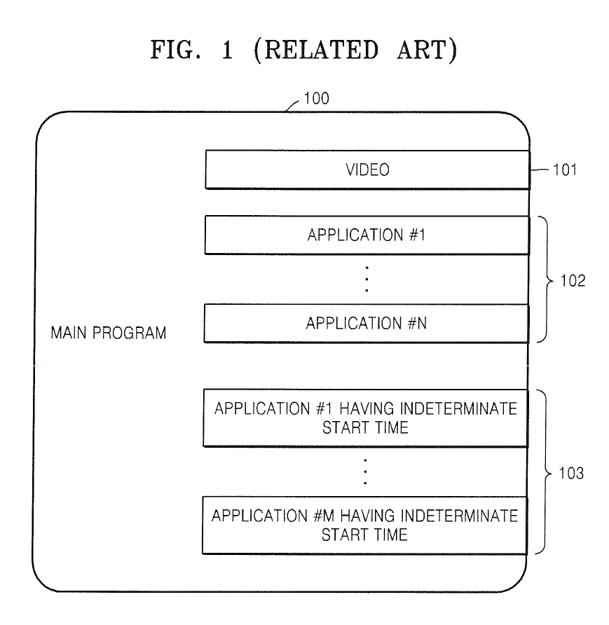

FIG. 1 is a diagram illustrating another related art audio visual (AV) data structure recorded on an information storage medium;

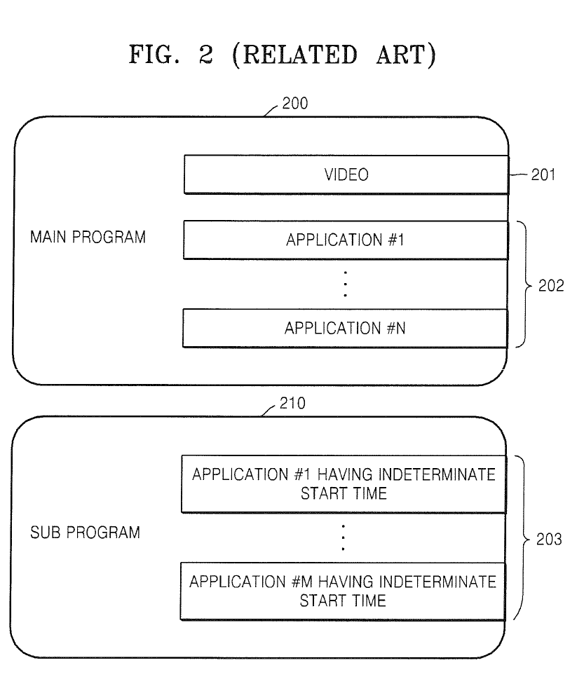

FIG. 3 is a diagram illustrating a related art structure of a reproduction apparatus;

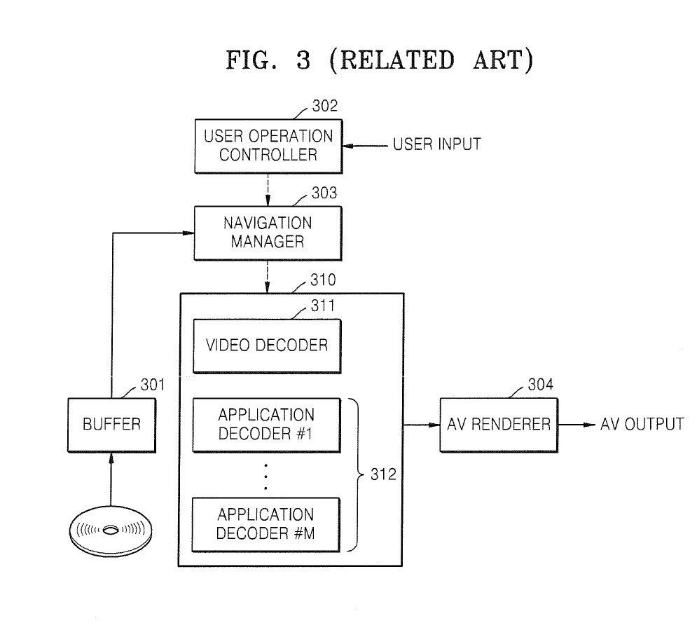

FIG. 4 is a diagram illustrating a structure of a reproduction apparatus according to an aspect of the present invention; and

FIG. 5 is a flowchart illustrating a reproduction method according to an aspect of the present invention.

### DETAILED DESCRIPTION OF THE EMBODIMENTS

Reference will now be made in detail to the aspects of the present invention, examples of which are illustrated in the accompanying drawings, wherein like reference numerals refer to the like elements throughout. The aspects are described below in order to explain the present invention by referring to the figures.

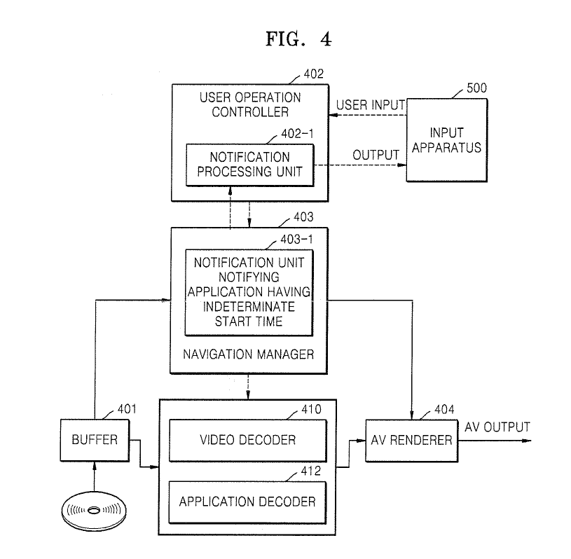

FIG. 4 is a diagram illustrating a structure of a reproduction apparatus according to an aspect of the present invention. The reproduction apparatus includes a user operation controller 402 to interpret (read or receive) control information input by a user using an input apparatus 500 and to transfer the result of the input to a navigation manager 403. The navigation manager 403 controls reproduction of AV data based on the reproduction sequence information of the AV data and the reproduction control information input from the user operation controller 402. Additionally, the reproduction apparatus includes a video decoder 410 to process video data included in the AV data based on control of the navigation manager 403, at least one application decoder 412 to process application data included in the AV data based on control of the navigation manager 403, and an AV renderer 404 to render the video and audio data decoded and output by the video decoder 410 and the at least one application decoder 412, to thereby output the AV data onto a screen. Also, the reproduction apparatus includes a buffer 401 to buffer AV data read from an information storage medium. However, if the AV data is read from the information storage medium at high speeds, it is understood that the buffer 401 may not be required and be omitted.

During operation of the reproduction apparatus, if the result of interpreting the reproduction sequence information to control the reproduction of AV data indicates that an application having an indeterminate start time (a selectable application) and whose start time is determined by a user's input is included in a main program or in a sub program, a notification unit 403-1 in the navigation manager 403 informs the user operation controller 402 about the application.

In various aspects of the present invention, an application broadly refers to a stream and/or a group of files (or data) defined in a variety of moving picture standards (such as MPEG2, October 2000 version) to implement audio, captions, and/or menus that can be reproduced together with video data. Examples of the application decoder 412 include audio decoders to decode audio streams, caption decoders to decode caption streams, menu decoders to decode menu streams, programming engines to interpret and process execution files written in programming languages, and presentation engines to interpret and process static documents.

in the shown aspect, while video is being reproduced, the navigation manager 403 notifies the user operation controller 402 about information on an application having an indeterminate start time. The notification thereof occurs at a time when the application having an indeterminate start time becomes valid (that is, when reading of the application data to execute the application from the information storage medium is finished and the application data begins to wait for a decoding operation). In the case where the reproduction sequence information includes information on a valid period in which the application having an indeterminate start time becomes valid, the navigation manager 403 maintains a state during this period in which the application is executable by means of a user input. In other aspects, notification that applications would become executable is also within the scope of the invention, and notification could be omitted where a default setting is to execute the application.

However, if the period lapses and the application becomes invalid, the notification unit 403-1 informs a notification processing unit 402-1 that the application is not executable or that no executable application currently exists. In other aspects, notification that the application would no longer be executable is also within the scope of the invention.

Meanwhile, when the reproduction apparatus is set to display information on an application having an indeterminate start time, the information can be output onto the OSD screen. When the information on the application having an indeterminate start time is set to be not displayed on the OSD screen, the information may be notified (or transmitted) to the user operation controller 402 so that the user can be notified about the information by using the input apparatus 500.

If the notification of an included application having an indeterminate start time is sent by the notification unit 403-1, and is received by the notification processing unit 402-1 in the user operation controller 402, the notification processing unit 402-1 controls the input apparatus 500 to output a predetermined information indicating that an application executable by way of a user input exists in the AV data currently being reproduced. Also, if a notification of invalidity of the application having an indeterminate start time, or non-existence of executable application having an indeterminate start time is sent by the notification unit 403-1, and is received by the notification processing unit 402-1, the notification processing unit 402-1 changes or deletes the output of the input apparatus 500. However, it is understood that the output could be separate from the input apparatus 500.

The input apparatus 500 is an apparatus that transmits or is capable of transmitting a user's input to the reproduction apparatus. In various aspects, the input apparatus 500 may be a remote controller and/or a front panel of the reproduction apparatus, although it is not limited to a particular type of an apparatus. If the input apparatus 500 is a remote controller, the notification processing unit 402-1 controls turning on/off of a predetermined light-emitting diode (LED) or vibration thereof, and if the input apparatus 500 is a front panel of the reproduction apparatus, the notification processing unit 402-1 can control the front panel so that a preset sentence (or a notice) can be displayed, by way of example, on a screen. If the user watches the information outputted from the input apparatus 500 and manipulates the input apparatus 500 so that the application can be executed, the user operation controller 402 interprets the control information that is input by using the input apparatus 500, and transfers the interpretation (or interpreted) result to the navigation manager 403. Then, in order to execute the application, the navigation manager 403 commands (or controls) the application decoder 412 to interpret and decode the application data.

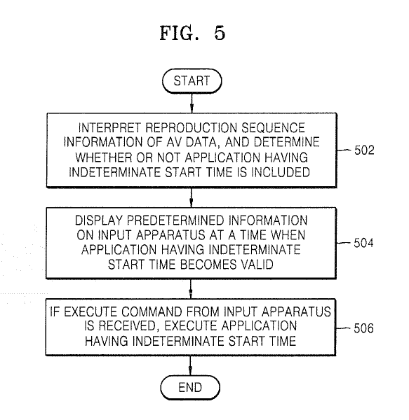

FIG. 5 is a flowchart illustrating a reproduction method according to an aspect of the present invention. Referring to FIG. 5, during reproducing of AV data, the reproduction sequence information of the AV data is interpreted, to thereby determine whether an application having an indeterminate start time exists, in operation 502. If it is determined that an application having an indeterminate start time exists, information on the application is displayed on an input apparatus at a time when the application becomes valid (that is, when the application becomes executable), in operation 504. If a user views the information displayed on the input apparatus and inputs a command to execute the application by manipulating the input apparatus, and the input execution command is received, the application data is decoded and executed, in operation 506.

According to the method and apparatus of aspects of the present invention as described above, a notice is output that an application having an indeterminate start time is included, which allows a user to learn (or be notified), and enables the user to easily use all applications provided by content producers.

Aspects of the medium include compact discs (CD), digital versatile discs, blue-ray discs (BD), high definition DVDs (HD-DVD), or something similar.

Moreover, while described in terms of a reproducing apparatus, it is understood the apparatus can further record data in other aspects of the present invention.

Aspects of the present invention can also be embodied as computer readable codes on a computer readable recording medium. The computer readable recording medium is any data storage device that can store data which can be thereafter read by a computer system.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A method of reproducing audio visual (AV) data comprising:
reading reproduction sequence information of the AV data and determining whether an application having an indeterminate start time is included; and
if the application is included, displaying on an input apparatus that the application exists and is executable.

2. The method of claim 1, further comprising, if a command from the input apparatus to execute the application is received, executing the application.

3. The method of claim 1, wherein the displaying on the input apparatus is performed at a time when reading of application data to execute the application is completed.

4. The method of claim 1, wherein the displaying on the input apparatus is performed when information on the application is set to be not displayed as an on-screen display (OSD).

5. The method of claim 1, wherein the input apparatus is a remote controller and/or a front panel of an apparatus to reproduce the AV data.

6. An apparatus to reproduce audio visual (AV) data comprising:
a user operation controller to control an input apparatus; and
a navigation manager to read reproduction sequence information of the AV data, to thereby control the reproduction of the AV data, and if determined that an application having an indeterminate start time is included, notifies the user operation controller of the inclusion,
wherein if the notification from the navigation manager is received, the user operation controller controls the input apparatus so that the presence of an executable application is indicated.

7. The apparatus of claim 6, wherein if a command from the input apparatus to execute the application is received, the user operation controller generates reproduction control information corresponding to the command and transfers the control information to the navigation manager, and the navigation manager controls an application decoder corresponding to the application by referring the control information to the reproduction control information, so that the application is decoded and executed.

8. The apparatus of claim 6, wherein at a time when reading of application data to execute the application is completed, the navigation manager transfers the notification of the inclusion to the user operation controller.

9. The apparatus of claim 6, wherein when information on the application is set to be not displayed as an on-screen display (OSD), the navigation manager transfers the notification of the inclusion to the user operation controller.

10. The apparatus of claim 6, wherein the input apparatus is a remote controller and/or a front panel of the apparatus to reproduce AV data.
